(19) United States
(12) Patent Application Publication
(10) Pub. No.: US 2014/0348433 A1
(43) Pub. Date: Nov. 27, 2014

(54) IMAGE RECOGNITION METHOD AND DEVICE

(71) Applicant: Ningbo Huayi Jiye Information Technology Co., Ltd, Ningbo (CN)

(72) Inventor: Liang ZHU, Ningbo (CN)

(73) Assignee: Ningbo Huayi Jiye Information Technology Co., Ltd, Ningbo (CN)

(21) Appl. No.: 14/280,810

(22) Filed: May 19, 2014

(30) Foreign Application Priority Data
May 21, 2013 (CN) 201310190988.8

(51) Int. Cl. G06K 9/62

(52) U.S. Cl. CPC G06K 9/6201
USPC 382/217

(57) ABSTRACT

The invention relates to the field of image processing technology, in particular to an image recognition method and device, for the purpose of solving such a problem in the prior art that lower recognition accuracy is resulted from loss of key information (except a contour drawing) in the image due to adoption of an image recognition mode for image representation based on a contour drawing. The embodiment of the invention provides an image recognition method, including: to determine the triangle matching degree on the basis of a characteristic triangle determinated from the target image and a characteristic triangle determinated from the source image; and to determine image matching degree between the target image and the source image on the basis of the triangle matching degree determinated.

### FIELD OF THE INVENTION

The invention relates to the field of image processing technology, in particular to an image recognition method and device.

### BACKGROUND OF THE INVENTION

As a technology using computers instead of human eyes for automatic recognition of images, the image recognition technology is widely used in security monitoring, criminal tracker and the like.

At present, what is commonly used in computer image recognition methods is the contour recognition method, i.e. the matching degree between the target image and the source image is determinated by comparing the contour features between the target image and the source image. For example, in the process of tracking a criminal, the contour drawing of the photo (the source image) of the criminal given is extracted, and then target image matched with the contour drawing is searched from surveillance videos.

However, a lot of image information inside and outside the contour is unable to be embodied by a contour drawing which is unable to entirely cover complete information of the source image because the contour drawing of the source image extracted only is a closed curve contained in the source image. Therefore, adoption of a contour drawing for representation of image characteristics may lead to nonrecognition or misrecognition of the source image due to loss of key image information.

To sum up, adoption of an image recognition mode for image representation based on a contour drawing may result in lower recognition accuracy due to loss of key information (except a contour drawing) in the image.

### SUMMARY OF THE INVENTION

The invention relates to the field of image processing technology, in particular to an image recognition method and device, for the purpose of solving such a problem in the prior art that lower recognition accuracy is resulted from loss of key information (except a contour drawing) in the image due to adoption of an image recognition mode for image representation based on a contour drawing.

The embodiment of the invention provides an image recognition method, including:

to determine triangle matching degree on the basis of the characteristic triangle determinated from target images and the characteristic triangle determinated from source images; wherein, among three vertexes of the characteristic triangle, a first coordinate value of any vertex is the coordinate value of at least a pixel point corresponding to the vertex along a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value;

and to determine image matching degree between the target images and the source images on the basis of the triangle matching degree determinated.

The embodiment of the invention provides an image recognition device, including:

a first determination module for determining triangle matching degree on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex in a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value;

and a second determination module for determining the image matching degree between the target image and the source image on the basis of the triangle matching degree determinated.

In the embodiment of the invention, the triangle matching degree is determined on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex along a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value, and the image matching degree between the target image and the source image is determined on the basis of the triangle matching degree determinated; in the embodiment of the invention, characteristic triangles are used for respective representation of image information of the target image and the source image, characteristic triangles not only can represent information of a contour drawing, but also can represent image information inside and outside the contour, thus comparatively completely representing the image information of the target image and the source image, reducing leaking recognition and misrecognition, and improving the recognition accuracy.

### BRIEF DESCRIPTION OF THE DRAWINGS

FIG. 1 is a flow diagram regarding the image recognition method provided by the embodiment of the invention;

FIG. 2 is a chromatogram II curve drawn in the embodiment of the invention on the basis of the first line pixel point in the target image;

FIG. 3 is a schematic diagram of the characteristic triangle determinated in the embodiment of the invention on the basis of the first line pixel point in the target image;

FIG. 4 is a schematic diagram for determinating the triangle matching degree by small shift in allusion to the L^{th} line pixel point set of the target image and the source image in the embodiment of the invention when the quantity of the target images is less than that of the source images;

FIG. 5 is a flow diagram regarding the image recognition method provided by a preferred embodiment of the invention;

FIG. 6 is a chromatogram curve drawn in the embodiment of the invention on the basis of accumulated line pixel points in the target image;

FIG. 7 is a schematic diagram of the characteristic triangle determinated in the embodiment of the invention on the basis of the accumulated line pixel points in the target image; and

FIG. 8 is a structure diagram regarding the image recognition device provided by the embodiment of the invention.

### DETAILED DESCRIPTION OF THE PREFERRED EMBODIMENTS

In order to ensure the objectives, the technical schemes and advantages of the embodiment of the invention to be more clearly, a clear and complete description of the technical schemes in the embodiment of the invention is made in combination with the accompanying drawings in the embodiment of the invention. Obviously, the embodiment is a part of embodiments of the invention instead of all embodiments. On the basis of the embodiment of the invention, all other embodiments obtained by those of ordinary skill in the art under the premise of not contributing creative labor are within the scope of protection of the invention.

In the embodiment of the invention, the triangle matching degree is determined on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex along a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value, and the image matching degree between the target image and the source image is determined on the basis of the triangle matching degree determinated; in the embodiment of the invention, characteristic triangles are used for respective representation of image information of the target image and the source image, characteristic triangles not only can represent information of a contour drawing, but also can represent image information inside and outside the contour, thus comparatively completely representing the image information of the target image and the source image, reducing leaking recognition and misrecognition, and improving the recognition accuracy.

Further detailed description of the embodiment of the invention is made in combination with drawings of the specification.

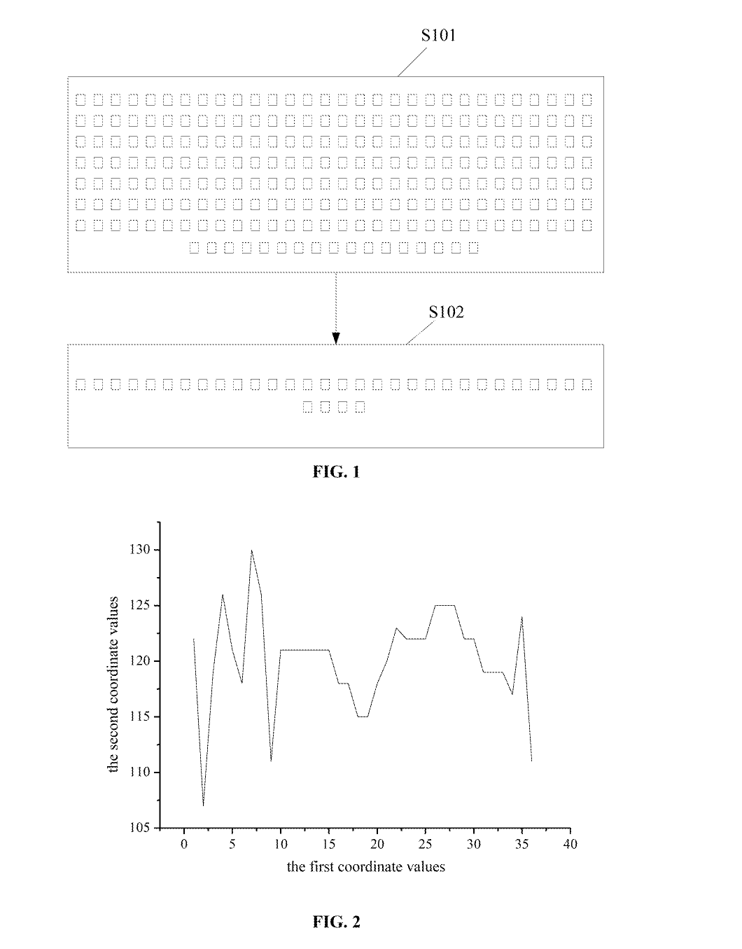

FIG. 1 is a flow diagram regarding the image recognition method provided by the embodiment of the invention, including the following steps:

S101: the triangle matching degree is determined on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex along a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value;

S102: the image matching degree between the target image and the source image is determined on the basis of the triangle matching degree determinated.

In the Step S101, in a plane-coordinate system, the first coordinate value can be an x-coordinate value, and the second coordinate value can be a y-coordinate value; or the first coordinate value is a y-coordinate value, and the second coordinate value is an x-coordinate value; wherein the second coordinate value is the equivalent gray value corresponding to the vertex of the characteristic triangle; the equivalent gray value can be either the average gray value of at least a pixel point corresponding to the equivalent gray value, or a gray value obtained by subtracting the gray value given from the average gray value of the at least a pixel point; for example, the average gray value of the source image can be taken as the gray value given, the equivalent gray value is the difference value between the average gray value of the at least a pixel point corresponding to the equivalent gray value and the average gray value of the source image, i.e. the gray value corresponding to the at least a pixel point after both the source image and the target image are taken under a grayscale image of the same level;

In concrete implementation process, if the source image the target image are color images, firstly the source image the target image are respectively taken under a grayscale image, then the characteristic triangle is determinated by using the grayscale image, and the gray value of each pixel point in the grayscale image is the luminance value of the pixel point; there are many methods for taking the source image the target image under a grayscale image, for example, the mean value method, the gray value of a pixel point can be calculated by the following formula: Gray=(Red value R+green value G+blue value B)/3; the gray value can also be expressed by the luminance value Y of a color image, under the circumstance, the gray value can be determinated by the transformational relation between a color image YUV representation method and RGB representation method, in the YUV representation method, component Y represents luminance signal, U and V represent color difference signal; therefore, the component Y is enough to express complete information of the grayscale image, here the luminance value Y (gray value Gray)=Rx0.3+Gx0.59+Bx0.11; also the source image and the target image are taken under a grayscale image of the same level, i.e. after the source image and the target image are taken under the grayscale image, the gray value of each pixel point is the difference value between the actual gray value and the average gray value of the source image.

One of key points for image recognition is to distinguish the luminance value contrast ratio of different images, on the basis of which, in the embodiment of the invention, the basic rule for determinating a characteristic triangle is that after three vertexes of the characteristic triangle are sorted on the basis of the first coordinate values, the difference value of the second coordinate values of two adjacent vertexes is not less than a given threshold value, for example, the coordinate values of three vertexes of the first characteristic triangle determinated respectively are (1, 122), (2, 107) and (4, 126), the x-coordinates of the three vertexes are pixel points corresponding to the three vertexes in the setting direction, for example, coordinate values in the right transverse direction, here the unit is counted by pixel points, the y-coordinates are the equivalent gray values of the pixel points corresponding to the three vertexes; sorted by x-coordinates, (1, 122) and (2, 107) stand for two adjacent vertexes, (2, 107) and (4, 126) stand for two adjacent vertexes, the difference values between the second coordinate values (namely, y-coordinates) of the two groups of adjacent vertexes are 15 and 19 respectively, larger than the given threshold value (for example, 1).

In the embodiment of the invention, characteristic triangles can be used for respective representation of complete image information of the source image and the target image, covering image information inside and outside the outline, with higher recognition accuracy. In addition, the quantity of characteristic triangles for representation of image information is greatly less than that of image pixel points, thus simplifying image processing and improving the recognition efficiency to a great extent.

In concrete implementation process, firstly after the source image the target image are respectively taken under a grayscale image, then the characteristic points consisting of a first coordinate value and a second coordinate value are determinated on the basis of the equivalent gray value of each pixel point in the grayscale image; a characteristic point can be corresponding to a pixel point or a plurality of pixel points, for example, for determinating the characteristic triangle corresponding to each line pixel point, a characteristic point can be corresponding to a pixel point, wherein the first coordinate value can be the coordinate value of the pixel point corresponding to the characteristic point in the transverse direction, and the second coordinate value is the equivalent gray value of the pixel point corresponding to the characteristic point; for another example, for determinating characteristic triangles corresponding to accumulated line pixel points, the accumulated line pixel points are taken as a whole and each characteristic point can be corresponding to all pixel points whose x-coordinate values are the first coordinate values of the characteristic point; afterwards, the characteristic triangle consisting of characteristic points is determinated on the basis of characteristic points determinated and the rule.

Preferably, the rule for determinating a characteristic triangle also includes: points changing in rising or descending trend in terms of the second coordinate values are determinated on the basis of the order of the first coordinate values from small to large or from large to small, and these points changing in rising or descending trend are taken as the vertexes of the characteristic triangle; more particularly, the rule for determinating a characteristic triangle also includes: the minimum or maximum characteristic point of the first coordinate value is taken as a vertex for determinating the first characteristic triangle;

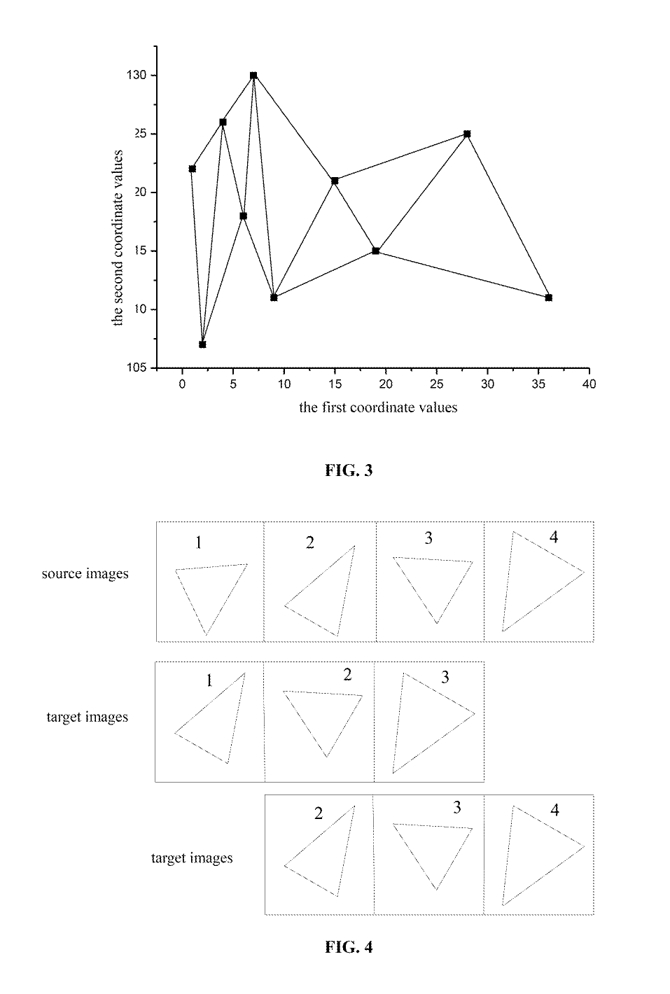

In concrete implementation, for more intuitively embodying pixel point information, a chromatogram II curve can be drawn on the basis of the characteristic points above-mentioned. FIG. 2 shows a chromatogram II curve drawn in the embodiment of the invention on the basis of the first line pixel point in the target image, the points in the curve are the characteristic points above-mentioned, wherein the x-coordinate value of each characteristic point is the first coordinate value of the pixel point corresponding to the characteristic point in right transverse direction, and the y-coordinate value is the equivalent gray value of the pixel point corresponding to the characteristic point. Inflection points in the chromatogram curve can be vertexes of the characteristic triangle, the inflection points are points changing in rising or descending trend in terms of the second coordinate values (namely the equivalent gray values) on the basis of the order of the first coordinate values from small to large or from large to small; in concrete implementation, other rules for determinating a characteristic triangle can be added according to actual demands, for example, if the difference values between the second coordinate value of a next characteristic point of an inflection point and the second coordinate value of the inflection point (or equivalent second coordinate value) are within the scope of a given threshold value, the inflection point with the maximum first coordinate value in the next a or next a plurality of characteristic points is taken as the actually required inflection point; for example, on the basis of the order of the first coordinate values from small to large, there are four characteristic points: (8, 126), (9, 111), (10, 121) and (11, 121) successively, the characteristic point (10, 121) is determinated as an inflection point (the second coordinate values are changed from a descending trend to a rising trend), however, the next characteristic point (11, 121) of the inflection point has the same second coordinate value as the inflection point. Therefore, the characteristic point (11, 121) is determinated as the actually required inflection point, accordingly, if the next characteristic point of the characteristic point (11, 121) is (12, 121), the characteristic point (12, 121) is determinated as the actually required inflection point because the characteristic point (12, 121) has the same second coordinate value as the previous characteristic point (11, 121); for another example, in the process of determinating inflection points on the basis of the order of the first coordinate values from small to large or from large to small, compared with the inflection point, if the rising or descending trend of the second coordinate value of the next characteristic point of the inflection point is changed (i.e. the concrete value changed regarding the rising or descending trend of the second coordinate value is greater than the given threshold value), the average value of the second coordinate values of the inflection point and the next characteristic point is determinated; compared with a characteristic point prior to the inflection point, if the rising or descending trend of the second coordinate value of the average value is not changed at all or changed but not more than the given threshold value, the inflection point is filtered out, in other words, the inflection point is not the inflection point required actually, and all determinate inflection points required actually are vertexes of the characteristic triangle; on the basis of the order of the first coordinate values from small to large, there are four characteristic points: (33, 119), (34, 117), (35, 124) and (36, 111) successively, according to the rule mentioned above, the characteristic point (35, 124) is an inflection point; however, compared with the inflection point, the rising or descending trend of the second coordinate value of the next characteristic point (36, 111) of the inflection point is changed, and the average value of the second coordinate values of characteristic points (35, 124) and (36, 111) is 117.5 (0.5 more than the second coordinate value 117, less than the given threshold value 1), therefore, the characteristic point (35, 124) is not the inflection point required actually.

Preferably, in Step S101, both the characteristic triangle determinated from the target image and the characteristic triangle determinated from the source image are successively determinated on the basis of coordinate values of image pixel points along the setting direction; wherein, except the characteristic triangle whose vertex has the maximum first coordinate value, two vertexes of any characteristic triangle whose first coordinate values are posterior are simultaneously two vertexes of another characteristic triangle whose first coordinate values are anterior.

In concrete implementation process, the rule for determinating characteristic triangles for the source image and the target image also includes: except the characteristic triangle whose vertex has the maximum first coordinate value, two vertexes of any characteristic triangle whose first coordinate values are posterior are simultaneously two vertexes of another characteristic triangle whose first coordinate values are anterior; the total image information can be more completed represented by the rule for determinating characteristic triangles. In concrete implementation, if characteristic triangles are determinated according to the order (from small to large) of coordinate values of image pixel points in the setting direction, except the last characteristic triangle determinated, two vertexes of any characteristic triangle whose first coordinate values are posterior are simultaneously two vertexes of another characteristic triangle whose first coordinate values are anterior; if characteristic triangles are determinated according to the order (from large to small) of coordinate values of image pixel points in the setting direction, except the last characteristic triangle determinated, two vertexes of any characteristic triangle whose first coordinate values are anterior are simultaneously two vertexes of another characteristic triangle whose first coordinate values are posterior. FIG. 3 shows a schematic diagram of the characteristic triangle determinated in the embodiment of the invention on the basis of the first line pixel point in the target image; wherein, except the rule that two vertexes of any characteristic triangle whose first coordinate values are posterior are simultaneously two vertexes of another characteristic triangle whose first coordinate values are anterior, rules for determinating characteristic triangles also include other more specific rules, for example, a vertex of a first characteristic triangle consists of a first coordinate value and a second coordinate value corresponding to a first pixel point in each line; on the basis of the order of the first coordinate values from small to large or from large to small, characteristic points (i.e. inflection points) changed in rising or descending trend are taken as the vertexes of the characteristic triangle; if the difference values between the second coordinate value of a next characteristic point of an inflection point and the second coordinate value of the inflection point (or equivalent second coordinate value) are within the scope of a given threshold value, the inflection point with the maximum first coordinate value in the next a or next a plurality of characteristic points is taken as the actually required inflection point; in the process of determinating inflection points on the basis of the order of the first coordinate values from small to large or from large to small, compared with the inflection point, if the rising or descending trend of the second coordinate value of the next characteristic point of the inflection point is changed (i.e. the concrete value changed regarding the rising or descending trend of the second coordinate value is greater than the given threshold value), the average value of the second coordinate values of the inflection point and the next characteristic point is determinated; compared with a characteristic point prior to the inflection point, if the rising or descending trend of the second coordinate value of the average value is not changed at all or changed but not more than the given threshold value, the inflection point is filtered out, in other words, the inflection point is not the inflection point required actually, and all determinate inflection points required actually are vertexes of the characteristic triangle. In combination of FIG. 2, it can be seen that image information of the line pixel point can be relatively completely represented by the characteristic triangle determinated by the first line pixel point.

In determinating characteristic triangles, either characteristic triangles corresponding to each line and/or column pixel point can be respectively determinated, or characteristic triangles corresponding to accumulated line and/or column pixel point can be determinated; when the characteristic triangles corresponding to each line and/or column pixel point are respectively determinated, the first coordinate value and the second coordinate value mentioned above are respectively the coordinate value and the equivalent gray value of a single pixel point in the setting direction; when the characteristic triangles corresponding to accumulated line and/or column pixel point are determinated, the first coordinate values and the second coordinate values mentioned above are respectively the coordinate values and the equivalent gray values of a plurality of pixel points with the same first coordinate values in the setting direction. Here the setting direction is set according to actual conditions, for example, for determinating characteristic triangles corresponding to each line pixel point and/or accumulated line pixel points, the setting direction can be right transverse or left transverse; for determinating characteristic triangles corresponding to each column pixel point and/or accumulated column pixel points, the setting direction can be longitudinally downward or longitudinally upward. In concrete matching, the characteristic triangle corresponding to each line pixel point in the source image is matched with the characteristic triangle corresponding to each line pixel point in the target image, also the characteristic triangle corresponding to each column pixel point in the source image is matched with the characteristic triangle corresponding to each column pixel point in the target image, and also the characteristic triangle corresponding to each line pixel point in the source image is matched with the characteristic triangle corresponding to each column pixel point in the target image; matching of characteristic triangles between accumulated line pixel points and accumulated line pixel points, between accumulated column pixel points and accumulated column pixel points, and between accumulated line pixel points and accumulated column pixel points is conducted in a similar way similarly;

In concrete implementation process, characteristic triangles can be determinated from multi-angles of images, for example, after the characteristic triangles corresponding to each line or accumulated lines in the current source image are matched with the characteristic triangles corresponding to each line or accumulated lines in the target image, the source image can be rotated 90 degrees, and then the characteristic triangles corresponding to each line or accumulated lines in the source image rotated are matched with the characteristic triangles corresponding to each line or accumulated lines in the target image.

Preferably, in Step S101, the triangle matching degree includes the triangle area matching degree and/or the matching degree of difference value of the second coordinate values of two adjacent vertexes.

The triangle matching degree can be concretely determinated on the basis of the triangle area, or of the difference value between the second coordinate values of two adjacent vertexes, or of the triangle area and the difference value between the second coordinate values of two adjacent vertexes. It is necessary to state that, a characteristic triangle has two groups of the two adjacent vertexes, therefore, the difference value between the second coordinate values of the two adjacent vertexes is taken into account when the triangle matching degree is determinated on the basis of the difference value between the second coordinate values of the two adjacent vertexes; concretely, the sum of the absolute values of the difference values between the two groups of the second coordinate values can be used for representation of the matching degree of the difference values between the second coordinate values, for example, on the basis of the order of the first coordinate values from small to large, three vertexes are sorted as the first vertex, the second vertex and the third vertex successively, the sum of the absolute value of the difference value of the second coordinate values of the first vertex and the second vertex and that of the difference value of the second coordinate values of the second vertex and the third vertex is for representation of the matching degree of the difference value of the second coordinate values.

Preferably, the triangle matching degree includes the triangle area matching degree and the matching degree of the difference value of the second coordinate values.

The image matching degree between the target image and the source image is determinated on the basis of the triangle matching degree determinated, including:

The image matching degree between the target image and the source image is determinated on the basis of the triangle area matching degree determinated, the matching degree of difference value of the second coordinate values, the weight of the triangle area matching degree, and the weight of the matching degree of the difference value of the second coordinate values.

In the concrete implementation process, the weight of the triangle area matching degree and the weight of the matching degree of the difference value of the second coordinate values (i.e., the proportion of the triangle area matching degree and the matching degree of the difference value of the second coordinate values in the triangle matching degree) are respectively set, the image matching degree between the target image and the source image is determinated on the basis of the weight of the triangle area matching degree, the weight of the matching degree of the difference value of the second coordinate values, the triangle area matching degree and the matching degree of the difference value of the second coordinate values.

Preferably, in Step S101, the characteristic triangle determinated from the target image is determinated on the basis of each line pixel point set and/or each column pixel point set in the target image;

the characteristic triangle determinated from the source image is determinated on the basis of each line pixel point set and/or each column pixel point set in the source image;

wherein, any a line pixel point set includes at least a line pixel point, and any a column pixel point set includes at least a column pixel point.

Here, the line pixel point set includes each line pixel point and/or accumulated line pixel points mentioned above, and the column pixel point set includes each column pixel point and/or accumulated column pixel points mentioned above; the description that the characteristic triangle is determinated from each line pixel point set or each column pixel point set is seen in the description of determination of characteristic triangles corresponding to each line pixel point or column pixel point, accumulated line pixel points or accumulated column pixel points, not repeated any more here.

Preferably, in Step S101, the triangle matching degree is determinated on the basis of the characteristic triangle determinated from the target image and the characteristic triangle determinated from the source image, including:

In allusion to the L^{th} line pixel point set or column pixel point set of the target image and the L^{th} line pixel point set or column pixel point set of the source image, the matching degree of the corresponding characteristic triangles with the identical sequence values in the target image and the source image is determinated respectively; wherein, the source image is equal to the target image in size; the sequence values corresponding to the characteristic triangles are determinated, on the basis of the first coordinate values of vertexes of the characteristic triangles, by respectively sorting the characteristic triangles determinated by the target image and the characteristic triangles determinated by the source image;

if the quantity of the characteristic triangles determinated by the target image is greater than that of the characteristic triangles determinated by the source image, the sequence value of each characteristic triangle in the source image is respectively added by 1, then the matching degree of the characteristic triangles with the identical sequence values in the source image and the target image is determinated respectively on the basis of the sequence values modified; go back to the step in which the sequence value of each characteristic triangle in the source image is respectively added by 1 until the matching degree between the last characteristic triangle in the target image and the last characteristic triangle in the source image is determinated;

if the quantity of the characteristic triangles determinated by the target image is less than that of the characteristic triangles determinated by the source image, the sequence value of each characteristic triangle in the target image is respectively added by 1, then the matching degree of the characteristic triangles with the identical sequence values in the source image and the target image is determinated respectively on the basis of the sequence values modified; go back to the step in which the sequence value of each characteristic triangle in the target image is respectively added by 1 until the matching degree between the last characteristic triangle in the source image and the last characteristic triangle in the target image is determinated.

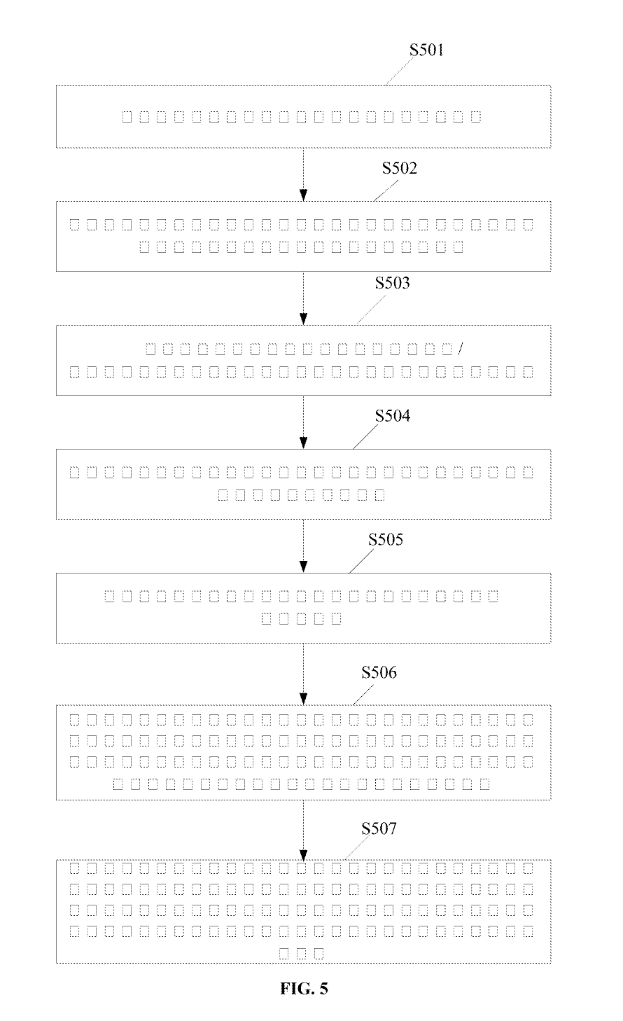

Here, the target image is equal to the source image in size, which means that the target image is equal to the source image in terms of side length and area, in other words, the target image is congruent to the source image; in concrete implementation process, the matching degree of each characteristic triangle is determinated successively by way of “small shift”; the basic thought is as below: in allusion to characteristic triangles corresponding to the L^{th} line pixel point set in the target image and the source image, on the basis of the order of the first coordinate values from small to large or from large to small, characteristic triangles in the target image and the source image are respectively sorted, with the sequence number being taken as the sequence values of the characteristic triangles, first the matching degree of characteristic triangles with the same sequence values are respectively determinated in the target image and the source image, if the characteristic triangles in the target image is equal to the characteristic triangles in the source image in terms of quantity, then after the matching degree of characteristic triangles with the same sequence values are determinated, characteristic triangles corresponding to L^{th} line pixel point set are matched; if the quantity of the characteristic triangles in the target image is larger than that of the characteristic triangles in the source image, then after the matching degree of characteristic triangles with the same sequence values are determinated, the sequence value of each characteristic triangle in the source image is respectively added by 1, then after sequence values are modified, the characteristic triangles in the source image are matched with the characteristic triangles in the target image with the same sequence values, i.e., the characteristic triangles in the source image are subject to small shift and then matched with the characteristic triangle in the target image; after the matching degree between the last characteristic triangle in the target image and the last characteristic triangle in the source image is determinated, the first matching degree and a plurality of shift matching degree are compared, wherein the maximum matching degree is taken as the matching degree corresponding to L^{th} line pixel point set; similarly, if the quantity of the characteristic triangles in the target image is less than that of the characteristic triangles in the source image, then after the matching degree of characteristic triangles with the same sequence values are determinated, the sequence value of each characteristic triangle in the target image is respectively added by 1, then after sequence values are modified, the characteristic triangles in the target image are matched with the characteristic triangles in the source image with the same sequence values, i.e., the characteristic triangles in the target image are subject to small shift and then matched with the characteristic triangle in the source image; after the matching degree between the last characteristic triangle in the source image and the last characteristic triangle in the target image is determinated, the first matching degree and a plurality of shift matching degree are compared, wherein the maximum matching degree is taken as the matching degree corresponding to L^{th} line pixel point set. FIG. 4 shows a schematic diagram for determinating the triangle matching degree by small shift in allusion to the L^{th} line pixel point set of the target image and the source image in the embodiment of the invention when the quantity of the characteristic triangles in the target image is less than that of the characteristic triangles in the source image.

Preferably, after Step S102, the invention also includes

Whether at least a target image in the target images is matched with the source image is judged on the basis of the matching degree between the source image and each target image which is extracted from the original images and is equal to the source image in size.

Preferably, whether at least a target image in the target images is matched with the source image is judged, including:

In allusion to any a target image, the matching degree between the target image and the source image is judged whether less than a first matching degree threshold value given, the target image is determined to be matched with the source image if the matching degree between the target image and the source image is confirmed not less than the first matching degree threshold value given; otherwise the target image is determined to be mismatched with the source image; or,

The maximum matching degree between the target image and the source image is determinated on the basis of the matching degree between each target image and the source image; the maximum matching degree is judged whether less than the first matching degree threshold value given, the target image corresponding to the maximum matching degree is determined to be matched with the source image if the maximum matching degree is confirmed not less than the first matching degree threshold value given; otherwise the target image corresponding to the maximum matching degree is determined to be mismatched with the source image.

In concrete implementation process, target images with the same size as the source image are extracted from original images obtained by shooting and video recording, the target images extracted are judged whether to be matched with the source image, concretely, after the matching degree between the target image and the source image is determinated, the matching degree is compared and judged whether to reach or exceed the first matching degree threshold value given for recognition of matching between the target image and the source image; the target images extracted are matched with the source image if the matching degree reaches or exceeds the first matching degree threshold value; in addition, after a plurality of matching degrees between the target image and the source image are determinated, the maximum matching degree thereof is compared with the first matching degree threshold value, the target image corresponding to the maximum matching degree is matched with the source image if the maximum matching degree reaches or exceeds the first matching degree threshold value.

Preferably, each target image which is equal to the source image in size is extracted from the original images according to the following steps:

The target images which are equal to the source image in size are shifted and extracted successively in different directions on the basis of extraction parameters given until the matching degree between the target images extracted and the source image reaches or exceeds the second matching degree threshold value given, then those target images extracted previously are taken as all target images extracted in the first round;

the position of the target image in all the target images extracted in the n^{th} round which has the maximum matching degree with the source image is taken as the starting point for the extraction in the (n+1)^{th} round, on the basis of which, different target images are shifted and extracted respectively in different directions;

wherein, the shift step length for shifting and extraction in different directions in the m^{th} round is less than or equal to the shift step length for shifting and extraction in different directions in the (m−1)^{th} round; both n and m are positive integers.

In concrete implementation process, different target images are extracted successively from original images by way of “large shift”; the basic thought is as below: target images are extracted on the basis of extraction parameters (for example, the original extraction position, the shift step length, and the shift direction etc.), the shift step length can be set half of the length of the source image in the shift direction before the matching degree between the target images extracted and the source image does not reach the second matching degree threshold value given; the mode of “screw shift” in the “large shift” is activated after the matching degree between the target images extracted and the source image reaches or exceeds the second matching degree threshold value given, generally, the second matching degree threshold value is less than the first matching degree threshold value, in other words, before target images extracted are matched with the source image and when target images extracted are possible to be mutually matched with the source image, the mode of “screw shift” is activated for fine searching and extraction; concretely, the position of the target image in all the target images extracted in the previous round which has the maximum matching degree with the source image is taken as the starting point for the extraction in the following round, on the basis of which, different target images are shifted and extracted respectively in different directions; the “screw shift” is repeated until all rounds set are finished, or until the target images extracted in the following round are the same as the target images extracted in the previous round, or until the matching degree between the target images extracted and the source image reaches the first matching degree threshold value given; in concrete implementation, the shift step length for shifting and extraction in the following round can be less than or equal to the shift step length for shifting and extraction in the previous round.

Preferably, after Step S102, the invention also includes

Users are instructed to judge whether the target image is matched with the source image if the matching degree between the target image and the source image is less than the third matching degree threshold value (signifying the target image is matched with the source image) and greater than the fourth matching degree threshold value given;

Parameters or rules for determinating the image matching degree are adjusted if such information is received from users that the target image is matched with the source image, so as to ensure the matching degree between the target image and the source image determinated after parameters or rules for determinating the image matching degree are adjusted is larger than the matching degree determinated previously between the target image and the source image.

In concrete implementation process, the mode of “self-adaption study” can be used for optimizing the third matching degree threshold value (signifying the target image is matched with the source image), here the third matching degree threshold value can be equal to the first matching degree threshold value mentioned above; in concrete implementation, the target image whose matching degree with the source image is less than the third matching degree threshold value but greater than the fourth matching degree threshold value is submitted to users as a suspect target image, and users are instructed to judge whether the target image is matched with the source image; parameters or rules for determinating the image matching degree are adjusted if such information is received from users that the suspect target image is matched with the source image, so as to ensure the matching degree between the suspect target image and the source image is not less than the third matching degree threshold value; here, parameters for determinating the image matching degree can be the weight of the triangle area matching degree and the weight of the matching degree of the difference value of the second coordinate values etc. Here, the rule for determinating the image matching degree can be adjusted according to actual demands, for example, if among characteristic triangles corresponding to the target images currently extracted, there are the same characteristic triangles in the suspect target image, the matching degree between the target images currently extracted and the source image is automatically determinated a value not less than the third matching degree threshold value. In this way, when another target image identical or similar to the suspect target image is extracted again, it can be automatically recognized. Hence, the recognition accuracy of the recognition system is higher and higher.

For further description of the image recognition method in the embodiment of the invention, a detailed description is made in combination with the accompanying drawings and an embodiment as below:

FIG. 5 is a flow diagram regarding the image recognition method provided by a preferred embodiment of the invention, including:

S501: target images which are equal to the source image in size are extracted from the original images;

In concrete implementation, the mode for extracting target images is the mode of “large shift” as mentioned above, not repeated any more here;

S502: the source image and the target images extracted from the original images are taken under a grayscale image of the same level; wherein the source image is equal to the target images in size;

Here, the source image and the target images extracted from the original images are taken under a grayscale image of the same level, which means that the equivalent gray value of each pixel point in the grayscale image is the difference value between the actual gray value of the pixel point and the average gray value of the source image;

S503: characteristic triangles in the source image and the target image are respectively determinated on the basis of each line pixel point and/or accumulated line pixel points in the grayscale image;

wherein, the rule for determinating a characteristic triangle includes: (I) among three vertexes of the characteristic triangle, the first coordinate value of any a vertex is the coordinate value of at least a pixel point corresponding to the vertex in the transverse direction, and the second coordinate value of the vertex is the equivalent gray value of the at least a pixel point, after three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value; (II) characteristic triangles are successively determinated on the basis of the order of the first coordinate values from small to large or from large to small, wherein, except the characteristic triangle whose vertex has the maximum first coordinate value, two vertexes of any characteristic triangle whose first coordinate values are posterior are simultaneously two vertexes of another characteristic triangle whose first coordinate values are anterior; (III) a vertex of a first characteristic triangle consists of a first coordinate value and a second coordinate value corresponding to a first pixel point in each line pixel point, or a first coordinate value and a second coordinate value corresponding to a first column pixel point in accumulated line pixel points; (IV) on the basis of the order of the first coordinate values from small to large or from large to small, characteristic points changed in rising or descending trend are determinated in the second coordinate values, and the characteristic points (i.e. inflection point) changed in rising or descending trend are taken as the vertexes of the characteristic triangle. In addition, more concrete rules can set, for example, if the second coordinate value of the next characteristic point of an inflection point is the same as that of the inflection point, or the difference value thereof is within the scope of a given threshold value, the inflection point with the maximum first coordinate value in the next characteristic point is taken as the inflection point required actually; for another example, in the process of determinating inflection points on the basis of the order of the first coordinate values from small to large or from large to small, compared with the inflection point, if the rising or descending trend of the second coordinate value of the next characteristic point of the inflection point is changed (i.e. the concrete value changed regarding the rising or descending trend of the second coordinate value is greater than the given threshold value), the average value of the second coordinate values of the inflection point and the next characteristic point is determinated; compared with a characteristic point prior to the inflection point, if the rising or descending trend of the second coordinate value of the average value is not changed at all or changed but not more than the given threshold value, the inflection point is filtered out, in other words, the inflection point is not the inflection point required actually, and all determinate inflection points required actually are vertexes of the characteristic triangle.

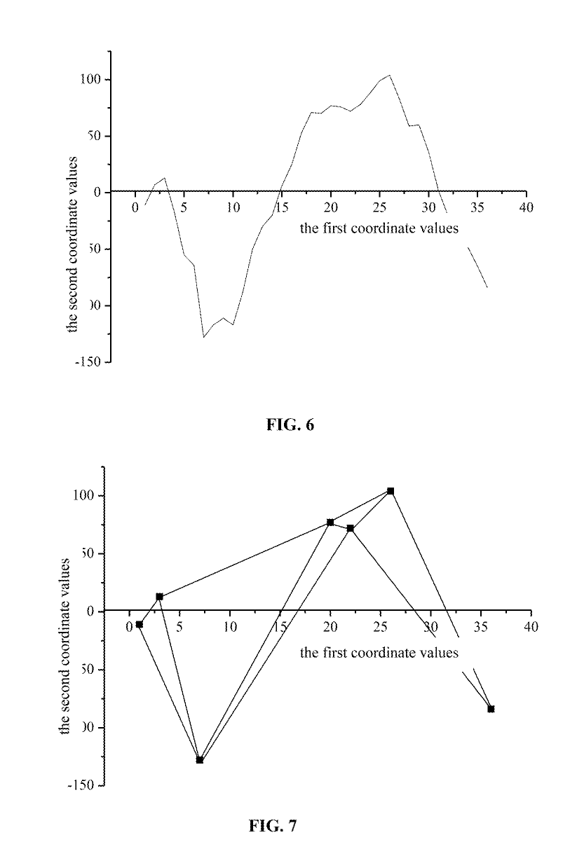

Here, accumulated line pixel points can be accumulation of all line pixel points in the target image or the source image, in other words, the second coordinate value of the characteristic triangle corresponding to accumulated line pixel points is corresponding to the equivalent gray value of a certain column pixel point, the accumulated line pixel points can also be accumulation of a part of line pixel points in the target image or the source image; FIG. 6 shows a chromatogram II curve drawn in the embodiment of the invention on the basis of accumulated line pixel points in the target image; the x-coordinate value in the curve is the coordinate value of the pixel point in right transverse direction, and the y-coordinate value is the equivalent gray value of each column pixel point with the same x-coordinate, here the equivalent gray value is the difference value between the average gray value of each column pixel point and the average gray value of the source image; FIG. 7 shows a schematic diagram of the characteristic triangle determinated in the embodiment of the invention on the basis of the accumulated line pixel points in the target image; in combination of FIG. 6 and FIG. 7, it can be seen that image information of the accumulated line pixel points can be relatively completely represented by the characteristic triangle determinated by the accumulated line pixel point.

S504: the triangle matching degree is determinated on the basis of the characteristic triangle determinated from the target image and the characteristic triangle determinated from the source image:

In concrete implementation, the matching degree of characteristic triangles with the same corresponding sequence values in the target image and the source image is respectively determinated by small shift in allusion to the L^{th} line pixel point set or column pixel point set in the target image as well as the L^{th} line pixel point set or column pixel point set in the source image; if the quantity of characteristic triangles in the target image is different from that of characteristic triangles in the source image, the characteristic triangles of small quantity are shifted in order and then compared with the characteristic triangles of large quantity so as to determinate the triangle matching degree; simultaneously, the maximum matching degree determinated in shifting can be taken as the matching degree of the triangle corresponding to the L^{th} line pixel point set or column pixel point set.

S505: the image matching degree between the target image and the source image is determinated on the basis of the triangle matching degree determinated.

In concrete implementation, the image matching degree between the target image and the source image is determinated on the basis of the triangle area matching degree determinated, the matching degree of difference value of the second coordinate values of two adjacent vertexes, the weight of the triangle area matching degree, and the weight of the matching degree of difference value of the second coordinate values.

S506: the target image is judged whether to be matched with the source image on the basis of the image matching degree between the target image and the source image; the target image is submitted to users and users are instructed to judge whether the target image is matched with the source image if the target image is not matched with the source image but the matching degree between the target image and the source image is greater than the threshold value given;

S507: parameters or rules for determinating the image matching degree are adjusted if such information is received from users that the target image is matched with the source image, so as to ensure the matching degree between the target image and the source image determinated after parameters or rules for determinating the image matching degree are adjusted is larger than the matching degree determinated previously between the target image and the source image.

Based on the same inventive concept, the embodiment of the invention also provides an image recognition device corresponding to the image recognition method. The principle of the device for solving problems is similar to the image recognition method in the embodiment of the invention. Therefore, the implementation of the device can be seen in the implementation of the method, not repeated any more.

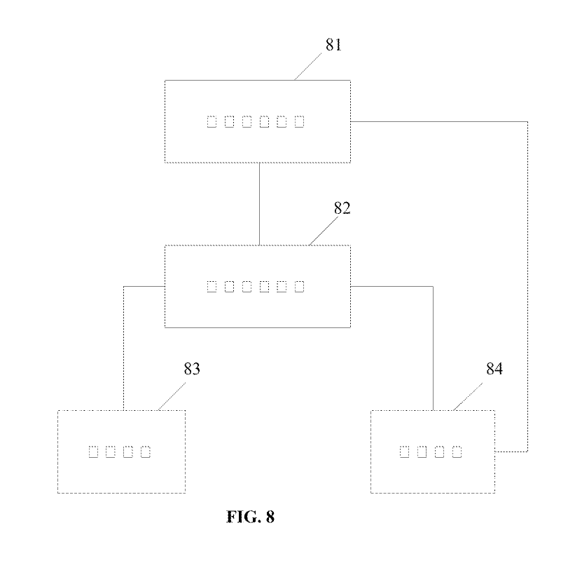

FIG. 8 shows a structure diagram of the image recognition device provided by the embodiment of the invention, including:

a first determination module 81 used for determinating the triangle matching degree on the basis of the characteristic triangle determinated from target image and the characteristic triangle determinated from source image; wherein, among three vertexes of the characteristic triangle, the first coordinate value of any vertex is the coordinate value of at least a pixel point corresponding to the vertex along a setting direction, the second coordinate value of the vertex is the equivalent gray value of the at least a pixel point, after the three vertexes of the characteristic triangle are sorted on the basis of the first coordinate values, the difference value of the second coordinate values of two adjacent vertexes is not less than the given threshold value; wherein, the equivalent gray value is the average gray value of the at least a pixel point, or the difference value between the average gray value of the at least a pixel point and the given gray value;

and a second determination module 82 used for determining the image matching degree between the target image and the source image on the basis of the triangle matching degree determinated by the first determination module 81.

Preferably, the first determination module 81 is concretely used for: successively determinating characteristic triangles on the basis of coordinate values of target image pixel points along the setting direction; wherein, except the characteristic triangle whose vertex has the maximum first coordinate value, two vertexes of any characteristic triangle whose first coordinate values are posterior are simultaneously two vertexes of another characteristic triangle whose first coordinate values are anterior; and/or successively determinating characteristic triangles on the basis of coordinate values of source image pixel points along the setting direction; wherein, except the characteristic triangle whose vertex has the maximum first coordinate value, two vertexes of any characteristic triangle whose first coordinate values are posterior are simultaneously two vertexes of another characteristic triangle whose first coordinate values are anterior.

Preferably, the triangle matching degree includes the triangle area matching degree and/or the matching degree of the difference value of the second coordinate values of the two adjacent vertexes.

Preferably, the triangle matching degree includes the triangle area matching degree and the matching degree of the difference value of the second coordinate values; the second determination module 82 is concretely used for determinating the image matching degree between the target image and the source image on the basis of the triangle area matching degree determinated, the matching degree of difference value of the second coordinate values, the weight of the triangle area matching degree, and the weight of the matching degree of difference value of the second coordinate values.

Preferably, the first determination module 81 is concretely used for: determinating characteristic triangles on the basis of each line pixel point set and/or each column pixel point set in the target image; and/or determinating characteristic triangles on the basis of each line pixel point set and/or each column pixel point set in the source image; wherein, any a line pixel point set includes at least a line pixel point, and any a column pixel point set includes at least a column pixel point.

Preferably, the first determination module 81 is concretely used for:

in allusion to the L^{th} line pixel point set or column pixel point set in the target image and the L^{th} line pixel point set or column pixel point set in the source image, determinating respectively the matching degree of the corresponding characteristic triangles with the identical sequence values in the target image and the source image; wherein, the source image is equal to the target image in size; the sequence values corresponding to the characteristic triangles are determinated, on the basis of the first coordinate values of vertexes of the characteristic triangles, by respectively sorting the characteristic triangles determinated by the target image and the characteristic triangles determinated by the source image;

If the quantity of the characteristic triangles determinated by the target image is greater than that of the characteristic triangles determinated by the source image, the sequence value of each characteristic triangle in the source image is respectively added by 1, then the matching degree of the characteristic triangles with the identical sequence values in the source image and the target image is determinated respectively on the basis of the sequence values modified; go back to the step in which the sequence value of each characteristic triangle in the source image is respectively added by 1 until the matching degree between the last characteristic triangle in the target image and the last characteristic triangle in the source image is determinated;

If the quantity of the characteristic triangles determinated by the target image is less than that of the characteristic triangles determinated by the source image, the sequence value of each characteristic triangle in the target image is respectively added by 1, then the matching degree of the characteristic triangles with the identical sequence values in the source image and the target image is determinated respectively on the basis of the sequence values modified; go back to the step in which the sequence value of each characteristic triangle in the target image is respectively added by 1 until the matching degree between the last characteristic triangle in the source image and the last characteristic triangle in the target image is determinated.

Preferably, the device also includes:

A judgment module 83, used for judging whether at least a target image in the target images extracted is matched with the source image on the basis of the matching degree between the source image and each target image which is extracted from the original images and is equal to the source image in size.

Preferably, the judgment module 83 is concretely used for:

in allusion to any a target image, judging whether the matching degree between the target image and the source image is less than the first matching degree threshold value given, the target image is determined to be matched with the source image if the matching degree between the target image and the source image is confirmed not less than the first matching degree threshold value given; otherwise the target image is determined to be mismatched with the source image; or,

on the basis of the matching degree between each target image and the source image, determinating the maximum matching degree between each target image and the source image; and judging whether the maximum matching degree is less than the first matching degree threshold value given, the target image corresponding to the maximum matching degree is determined to be matched with the source image if the maximum matching degree is confirmed not less than the first matching degree threshold value given; otherwise the target image corresponding to the maximum matching degree is determined to be mismatched with the source image.

Preferably, the judgment module 83 is concretely used for the following purposes:

the target images which are equal to the source image in size are shifted and extracted successively in different directions on the basis of extraction parameters given until the matching degree between the target images extracted and the source image reaches or exceeds the second matching degree threshold value given, then those target images extracted previously are taken as all target images extracted in the first round;

the position of the target image in all the target images extracted in the n^{th} round which has the maximum matching degree with the source image is taken as the starting point for the extraction in the (n+1)^{th} round, on the basis of which, different target images are shifted and extracted respectively in different directions;

wherein, the shift step length for shifting and extraction in different directions in the m^{th} round is less than or equal to the shift step length for shifting and extraction in different directions in the (m−1)^{th} round; both n and m are positive integers.

Preferably, the device also includes:

An adjustment module 84, used for instructing users to judge whether the target image is matched with the source image if the matching degree (determinated by the determination module 82) between the target image and the source image is less than the third matching degree threshold value (signifying the target image is matched with the source image) and greater than the fourth matching degree threshold value given;

parameters or rules for determinating the image matching degree are adjusted if such information is received from users that the target image is matched with the source image, so as to ensure the matching degree between the target image and the source image determinated after parameters or rules for determinating the image matching degree are adjusted is larger than the matching degree determinated previously between the target image and the source image.

Those skilled in the art shall understand that, the embodiment of the invention can be provided as a method, a system or a computer program product. Therefore, the invention can adopt the form of a full hardware embodiment, a full software embodiment, or combination of a full hardware embodiment and a full software embodiment. Furthermore, the invention can adopt the form of a computer program product implemented on a computer storage medium or a plurality of computer storage media (including but not limited to a magnetic disk memory, CD-ROM or an optical memory) including available computer program codes.

Description of the invention is made by referring to flow diagrams and/or block diagrams regarding the method, the device (system) and the computer program product according to the embodiment of the invention. It is understood that the computer program commands can be used for realization of each flow and/or block in the flow diagrams and/or block diagrams, and of combination of each flow and/or block in the flow diagrams and/or block diagrams. These computer program commands can be provided for general-purpose computers, special-purpose computers, embedded processors or other programmable data processors to generate a machine, so as to generate a device for realization of functions specified in a flow or a plurality of flows in the flow diagrams and/or a block or a plurality of blocks in the block diagrams by instructions executed by computers or other programmable data processors.

These computer program commands can be stored in computer-readable memories capable of guiding computers or other programmable data processors to work in the specified way, so that commands stored in the computer-readable memories generate manufactures including a command device; the command device can realize functions specified in a flow or a plurality of flows in the flow diagrams and/or a block or a plurality of blocks in the block diagrams.

These computer program commands can be loaded on computers or other programmable data processors so that a series of operation steps are executed on computers or other programmable data processors to generate processing realized by computers, thus providing steps for realization of functions specified in a flow or a plurality of flows in the flow diagrams and/or a block or a plurality of blocks in the block diagrams by instructions executed by computers or other programmable data processors.

Despite of description of preferred embodiments of the invention, those skilled in the art can, on the basis of basic creative concepts, change or modify these embodiments. Therefore, the attached claims intend to include preferred embodiments and all changes and modifications within the scope of the invention.

Obviously, under the premise of not against the spirit and scope of the invention, those skilled in the art can change or modify these embodiments. In this way, the invention intends to cover these changes and modifications as long as they are within the scope of the claims and equivalent technologies of the invention.

What is claimed is:

1. An image recognition method is characterized in comprising:
to determine the triangle matching degree on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex along a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value;
and to determine image matching degree between the target image and the source image on the basis of the triangle matching degree determinated.

2. The method as claimed in claim 1, wherein both the characteristic triangle determinated from the target image and the characteristic triangle determinated from the source image are successively determinated on the basis of coordinate values of image pixel points along the setting direction; wherein, except the characteristic triangle whose vertex has the maximum first coordinate value, two vertexes of any characteristic triangle whose first coordinate values are posterior are simultaneously two vertexes of another characteristic triangle whose first coordinate values are anterior.

3. The method as claimed in claim 1, wherein the triangle matching degree includes the triangle area matching degree and/or the matching degree of the difference value of the second coordinate values of the two adjacent vertexes.

4. The method as claimed in claim 3, wherein the triangle matching degree includes the triangle area matching degree and the matching degree of the difference value of the second coordinate values;
the image matching degree between the target image and the source image is determinated on the basis of the triangle matching degree determinated, including:
the image matching degree between the target image and the source image is determinated on the basis of the triangle area matching degree determinated, the matching degree of the difference value of the second coordinate values, the weight of the triangle area matching degree, and the weight of the matching degree of the difference value of the second coordinate values.

5. The method as claimed in claim 1, wherein the triangle matching degree determinated from the target image is determinated on the basis of each line pixel point set and/or each column pixel point set in the target image;
the characteristic triangle determinated from the source image is determinated on the basis of each line pixel point set and/or each column pixel point set in the source image;
wherein, any a line pixel point set includes at least a line pixel point, and any a column pixel point set includes at least a column pixel point.

6. The method as claimed in claim 5, wherein the triangle matching degree is determinated on the basis of the characteristic triangle determinated from the target image and the characteristic triangle determinated from the source image, including:
in allusion to the L^{th} line pixel point set or column pixel point set of the target image and the L^{th} line pixel point set or column pixel point set of the source image, the matching degree of the corresponding characteristic triangles with the identical sequence values in the target image and the source image is determinated respectively; wherein, the source image is equal to the target image in size; the sequence values corresponding to the characteristic triangles are determinated, on the basis of the first coordinate values of vertexes of the characteristic triangles, by respectively sorting the characteristic triangle determinated by the target image and the characteristic triangle determinated by the source image;
if the quantity of the characteristic triangles determinated by the target image is greater than that of the characteristic triangles determinated by the source image, the sequence value of each characteristic triangle in the source image is respectively added by 1, then the matching degree of the characteristic triangles with the identical sequence values in the source image and the target image is determinated respectively on the basis of the sequence values modified; go back to the step in which the sequence value of each characteristic triangle in the source image is respectively added by 1 until the matching degree between the last characteristic triangle in the target image and the last characteristic triangle in the source image is determinated;
if the quantity of the characteristic triangles determinated by the target image is less than that of the characteristic triangles determinated by the source image, the sequence value of each characteristic triangle in the target image is respectively added by 1, then the matching degree of the characteristic triangles with the identical sequence values in the source image and the target image is determinated respectively on the basis of the sequence values modified; go back to the step in which the sequence value of each characteristic triangle in the target image is respectively added by 1 until the matching degree between the last characteristic triangle in the source image and the last characteristic triangle in the target image is determinated.

7. The method as claimed in claim 1, wherein after the matching degree between the target image and the source image is determinated, it also includes:
whether at least a target image in the target images is matched with the source image is judged on the basis of the matching degree between the source image and each target image which is extracted from the original images and is equal to the source image in size.

8. The method as claimed in claim 7, wherein whether at least a target image in the target images is matched with the source image is judged, including:
in allusion to any a target image, the matching degree between the target image and the source image is judged whether less than a first matching degree threshold value given, the target image is determined to be matched with the source image if the matching degree between the target image and the source image is confirmed not less than the first matching degree threshold value given; otherwise the target image is determined to be mismatched with the source image; or,
the maximum matching degree between the target image and the source image is determinated on the basis of the matching degree between each target image and the source image; the maximum matching degree is judged whether less than the first matching degree threshold value given, the target image corresponding to the maximum matching degree is determined to be matched with the source image if the maximum matching degree is confirmed not less than the first matching degree threshold value given; otherwise the target image corresponding to the maximum matching degree is determined to be mismatched with the source image.

9. The method as claimed in claim 7, wherein each target image which is equal to the source image in size is extracted from the original images according to the following steps:
the target images which are equal to the source image in size are shifted and extracted successively in different directions on the basis of extraction parameters given until the matching degree between the target images extracted and the source image reaches or exceeds a second matching degree threshold value given, then those target images extracted previously are taken as all target images extracted in the first round;
the position of the target image in all the target images extracted in the n^{th} round which has the maximum matching degree with the source image is taken as the starting point for the extraction in the (n+1)^{th} round, on the basis of which, different target images are shifted and extracted respectively in different directions;
wherein, the shift step length for shifting and extraction in different directions in the m^{th} round is less than or equal to the the shift step length for shifting and extraction in different directions in the (m−1)^{th} round; both n and m are positive integers.

10. The method as claimed in claim 1, wherein after the matching degree between the target image and the source image is determinated, it also includes:
users are instructed to judge whether the target image is matched with the source image if the matching degree between the target image and the source image is less than a third matching degree threshold value (signifying the target image is matched with the source image) and greater than a fourth matching degree threshold value given;
parameters or rules for determinating the image matching degree are adjusted if such information is received from users that the target image is matched with the source image, so as to ensure the matching degree between the target image and the source image determinated after parameters or rules for determinating the image matching degree are adjusted is larger than the matching degree determinated previously between the target image and the source image.

11. An image recognition device is characterized in comprising:
a first determination module for determining triangle matching degree on the basis of the characteristic triangle determinated from the target image and the characteristic triangle determinated from the source image; wherein, among three vertexes of the characteristic triangle, a first coordinate value of any vertex is the coordinate value of at least a pixel point corresponding to the vertex in a setting direction, a second coordinate value of the vertex is the equivalent gray value of the at least a pixel point, after the three vertexes of the characteristic triangle are sorted on the basis of the first coordinate values, the difference value of the second coordinate values of two adjacent vertexes is not less than a given threshold value; wherein, the equivalent gray value is the average gray value of the at least a pixel point, or the difference value between the average gray value of the at least a pixel point and the given gray value;
and a second determination module for determining the image matching degree between the target image and the source image on the basis of the triangle matching degree determinated by the first determination module.

12. The device as claimed in claim 11, wherein the first determination module is particularly used for: determinating the characteristic triangle on the basis of each line pixel point set and/or each column pixel point set in the target image; and/or determinating the characteristic triangle on the basis of each line pixel point set and/or each column pixel point set in the source image;
wherein, any a line pixel point set includes at least a line pixel point, and any a column pixel point set includes at least a column pixel point.

13. The device as claimed in claim 12, wherein the first determination module is particularly used for:
in allusion to the L^{th} line pixel point set or column pixel point set in the target image and the L^{th} line pixel point set or column pixel point set in the source image, respectively determinating the matching degree of the corresponding characteristic triangles with the identical sequence values in the target image and the source image; wherein, the source image is equal to the target image in size; the sequence values corresponding to the characteristic triangles are determinated, on the basis of the first coordinate values of vertexes of the characteristic triangles, by respectively sorting the characteristic triangle determinated by the target image and the characteristic triangle determinated by the source image;
if the quantity of the characteristic triangles determinated by the target image is greater than that of the characteristic triangles determinated by the source image, the sequence value of each characteristic triangle in the source image is respectively added by 1, then the matching degree of the characteristic triangles with the identical sequence values in the source image and the target image is determinated respectively on the basis of the sequence values modified; go back to the step in which the sequence value of each characteristic triangle in the source image is respectively added by 1 until the matching degree between the last characteristic triangle in the target image and the last characteristic triangle in the source image is determinated;
if the quantity of the characteristic triangles determinated by the target image is less than that of the characteristic triangles determinated by the source image, the sequence value of each characteristic triangle in the target image is respectively added by 1, then the matching degree of the characteristic triangles with the identical sequence values in the source image and the target image is determinated respectively on the basis of the sequence values modified; go back to the step in which the sequence value of each characteristic triangle in the target image is respectively added by 1 until the matching degree between the last characteristic triangle in the source image and the last characteristic triangle in the target image is determinated.

14. The device as claimed in claim 11, wherein the device also comprising:
a judgment module, used for judging whether at least a target image in the target images is matched with the source image on the basis of the matching degree between the source image and each target image which is extracted from the original images and is equal to the source image in size.

15. The device as claimed in claim 14, wherein the judgment module is particularly used for the following purpose:
the target images which are equal to the source image in size are shifted and extracted successively in different directions on the basis of extraction parameters given until the matching degree between the target images extracted and the source image reaches or exceeds the second matching degree threshold value given, then those target images extracted previously are taken as all target images extracted in the first round;
the position of the target image in all the target images extracted in the n^{th} round which has the maximum matching degree with the source image is taken as the starting point for the extraction in the (n+1)^{th} round, on the basis of which, different target images are shifted and extracted respectively in different directions;
wherein, the shift step length for shifting and extraction in different directions in the m^{th} round is less than or equal to the the shift step length for shifting and extraction in different directions in the (m−1)^{th} round; both n and m are positive integers.
